(19) United States
(12) Patent Application Publication
(10) Pub. No.: US 2007/0100864 A1
(43) Pub. Date: May 3, 2007

(54) Client enterprise reference map

(76) Inventors: Jeffry L. Buchmiller, Pilot Point, TX (US); Thomas L. Hill, Dallas, TX (US); Doyle D. Abell, Plano, TX (US); Daniel M. Knisley, Concord, NC (US); Teresa L. Hanson, Aubrey, TX (US); Elizabeth A. Holland, Plano, TX (US); Geoffrey B. Charest, Shrewsbury, NJ (US); Pamela C. Llorence, Southfield, MI (US); Mary J. Evans, Arlington, VA (US); Arthur A. Hansen, Plano, TX (US); Fernando J. Bernal, Saginaw, MI (US)

Correspondence Address: GARDERE/EDS;GARDERE WYNNE SEWELL INTELLECTUAL PROPERTY, 3000 THANKSGIVING TOWER, 1601 ELM STREET, DALLAS, TX, 75201-4761, US

(21) Appl. No.: 11/260,947

(22) Filed: Oct. 28, 2005

(51) Int. Cl. G06F 7/00

(52) U.S. Cl. 707/102

(57) ABSTRACT

A method, system, and computer program product that provides a “Client Enterprise Reference Map” to model and to act upon the activities occurring at or on behalf of client enterprises of an outsourcing solutions provider in a general way, within an industry, for a client enterprise, and for any other use-specific scope is provided. The Client Enterprise Reference Map contains a representation of activities and work object flows in the Client Enterprise Reference Map Database. Diagrammatic views are generated from the Database using a method that can be implemented by a software program, so that the large effort in creating these views is automated each time the Database is updated due to newly acquired knowledge.

### BACKGROUND OF THE INVENTION

1. Technical Field

The present invention relates to software, and more particularly to business methods and, even more particularly, to methods of organizing and representing business activities and workflows.

2. Description of Related Art

Currently, outsourcing solutions, such as for Information Technology Outsourcing (ITO) and Business Process Outsourcing (BPO), are typically created based on the needs of a specific client enterprise. This is a problem for companies providing these solutions, in that they have many “custom” solutions to design, to develop, and to support. The current trend towards “off the shelf” solutions creates an environment where the only cost-effective way to create solutions is first to determine what the industry needs in the form of “How to perform key activities efficiently and effectively”, and then to develop these. Currently, however, it tends to be the reverse. One individual client enterprise requests a solution and the outsourcing solutions provider develops it. In order to provide better, more valuable, and more economical solutions to client enterprises' problems, and in order for the outsourcing solutions provider to remain a viable competitor in the future, this trend must be reversed.

Thus, in order to compete efficiently in the outsourcing solutions marketplace, an outsourcing solutions provider must have these solutions ready in large part before engaging with a client enterprise. An outsourcing solutions provider, based on its accumulated knowledge of the client enterprise's competitors, industry, and economic environment, must act in a focused and coordinated manner among its product and portfolio management, sales and marketing force, and solutions delivery divisions, and also with the client enterprise. Therefore, it would be desirable to have a mechanism that efficiently enables meaningful and correct communications between members of an outsourcing solutions provider as well as a common understanding of the client enterprise context and its needed solutions that the provider is to provide.

### SUMMARY OF THE INVENTION

The present invention provides a “Client Enterprise Reference Map” to model and to act upon the activities occurring at or on behalf of client enterprises of an outsourcing solutions provider in a general way, within an industry, for a client enterprise, and for any other use-specific scope. The Client Enterprise Reference Map contains a representation of activities and work object flows in the Client Enterprise Reference Map Database. Because the solution offerings can be targeted at any enterprise in the value network as a client, including the outsourcing solutions provider itself, the particular internal activities at which the service offerings are targeted can also be modeled, thus providing a continuous model including the client enterprise's activities, the outsourced services, our supporting activities, and all of the activities with which those interact at third-party organizations. Diagrammatic views are generated from the Database using a method that can be implemented by a software program, so that the large effort in creating these views is automated each time the Database is updated due to newly acquired knowledge.

The Client Enterprise Reference Map can be used to provide a “chart on the wall” to which multiple people refer when working on the development of a service offering, on its embodying solution, on a sale to a client, on delivery of the solution, or on management of its operation.

The Map can be used directly as a sales aid, to demonstrate to a client that the outsourcing provider understands their industry, what “best practice” activities and work flows are, and how to coordinate, implement, and execute those activities. The Map can be used in determining where to invest an outsourcing provider's capital in the future regarding the portfolio of solutions it provides, including software applications and service offerings. The Map enables an outsourcing provider to evaluate financial returns of its alternative efforts, with its cost-based and value-based overlays, so that the most valuable can be focused on. The Map may continue to evolve over time becoming very detailed, such as linking directly the key competitors' service offerings, which enables the service provider to perform competitive analysis both at the company level and per service offering.

The components of the Map as stored in the Database include the scope of the current view, activities, objects that flow from one activity to another, and overlay data. The scope of the current view can be generic cross-industry, industry-specific, or client-specific. Any activity can be added as the user of the method deems appropriate within a structure specific to the view. The material and informational objects that are outputs of one activity and inputs to another activity are represented as flowing from the one to the other. Overlays can be created to contain various data for various purposes, such as costs of operation for cost management, or outsourcing solution offerings offered by the user of the Map and by various competitors for competitive analysis.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server in accordance with the present invention;

FIG. 3 depicts a block diagram of a data processing system in which the present invention may be implemented;

FIG. Set 4 depict block diagrams representing the manner in which the present invention may be transformed into a computer application and presented to practitioners for application in the field in accordance with one embodiment of the present invention;

FIG. Set 5 provide related screenshots of a Beta version of a textual user interface which is exemplary of how the computer application may be presented to the users in accordance with one embodiment of the present invention;

FIG. 6 depicts a block diagram of a data base model in which the present invention may be implemented in accordance with one embodiment of the present invention;

FIG. 7 depicts an exemplary view of a client enterprise reference map is depicted in accordance with one embodiment of the present invention;

FIG. 8 depicts another view or that may be provided by the client enterprise reference map system in accordance with one embodiment of the present invention; and

FIG. 9 depicts a portion of map in FIG. 8 zoomed in on to show greater detail.

### DETAILED DESCRIPTION OF THE PREFERRED EMBODIMENT

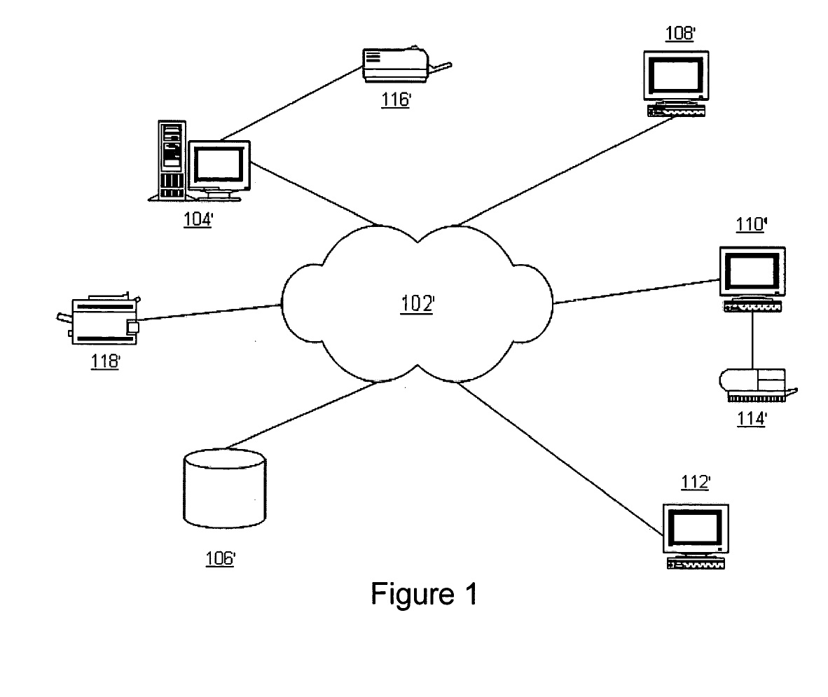

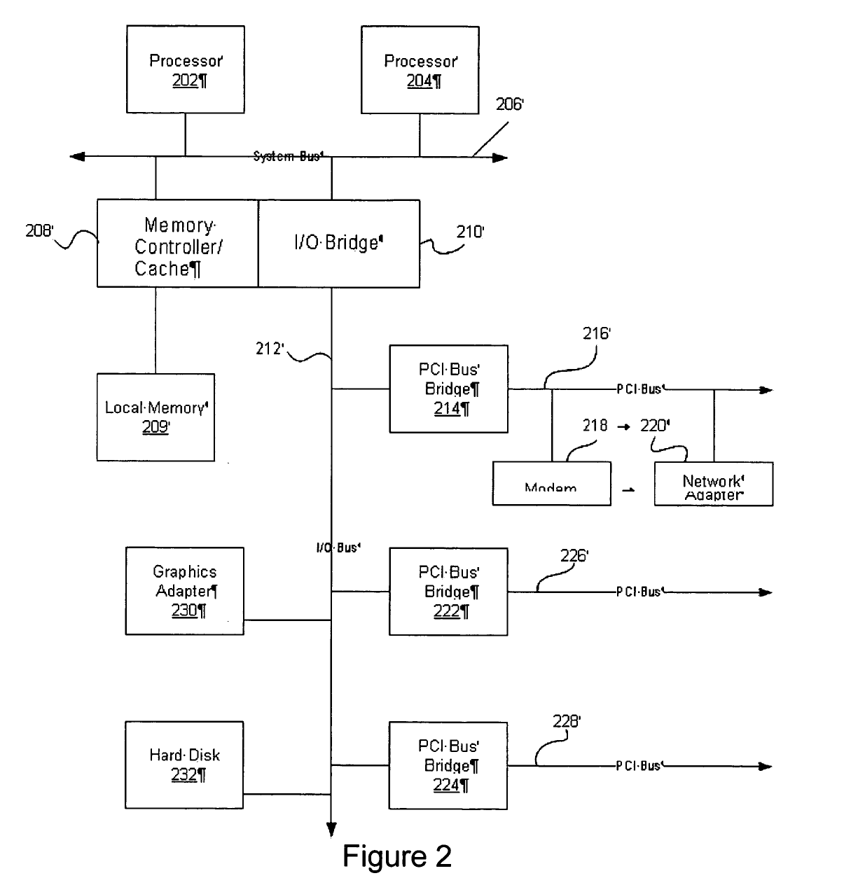

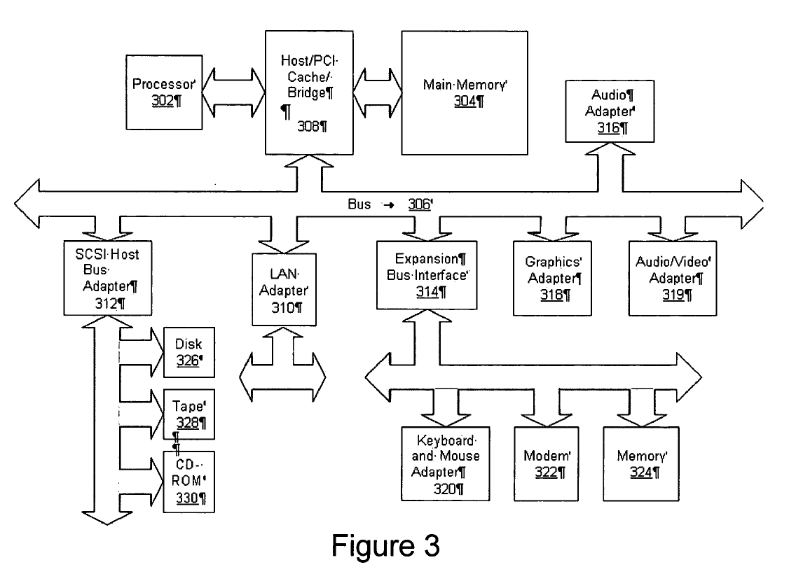

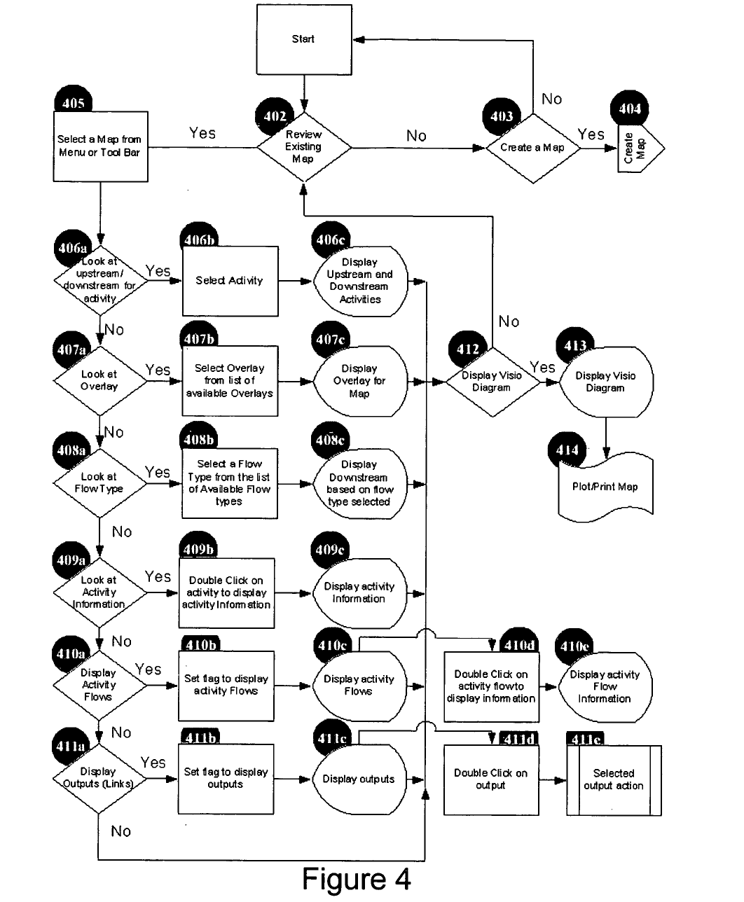

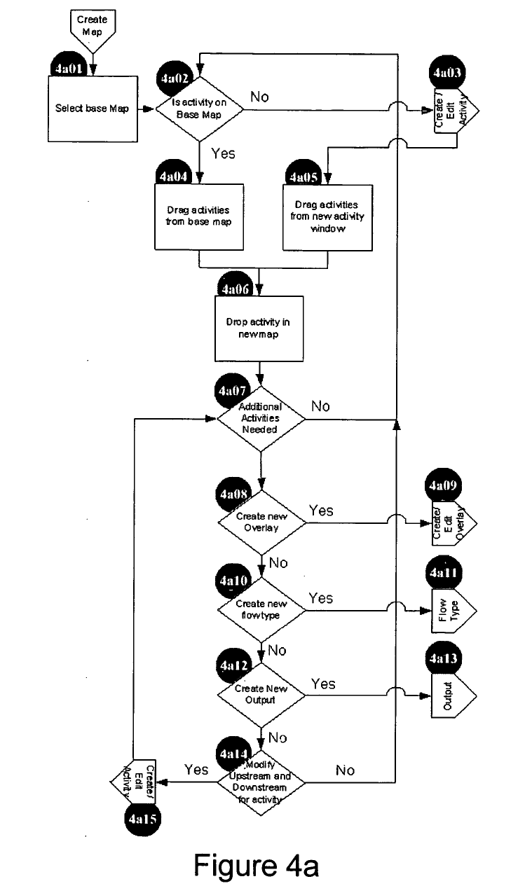

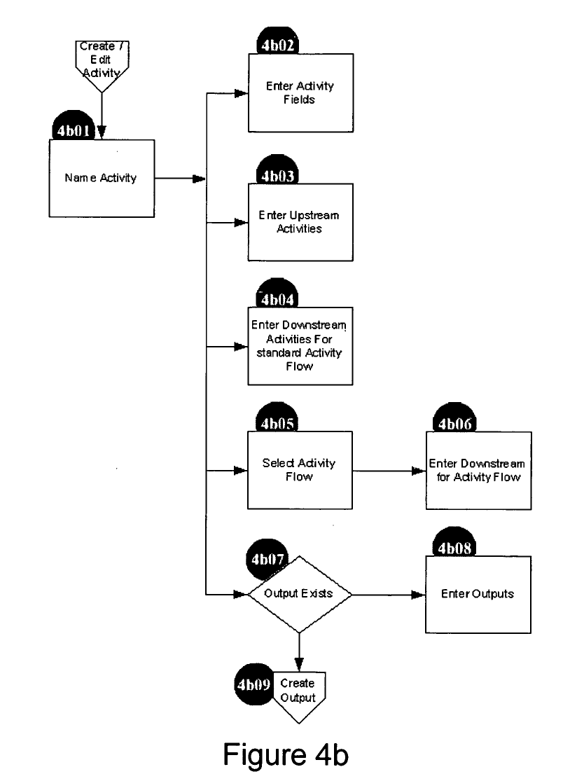

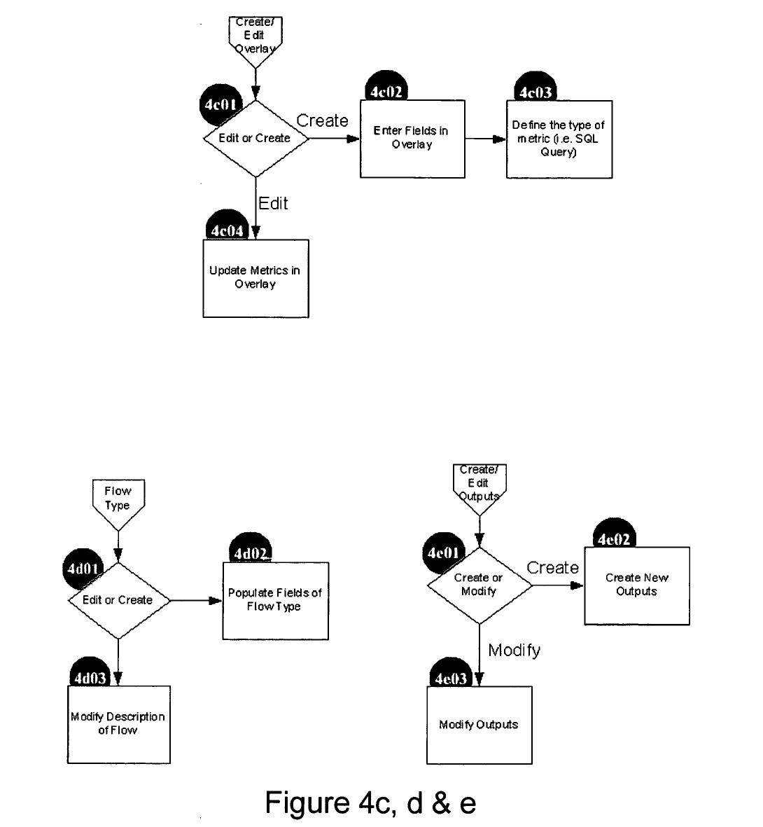

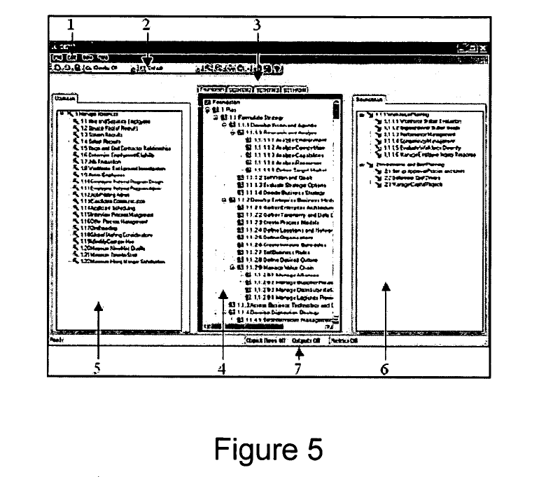

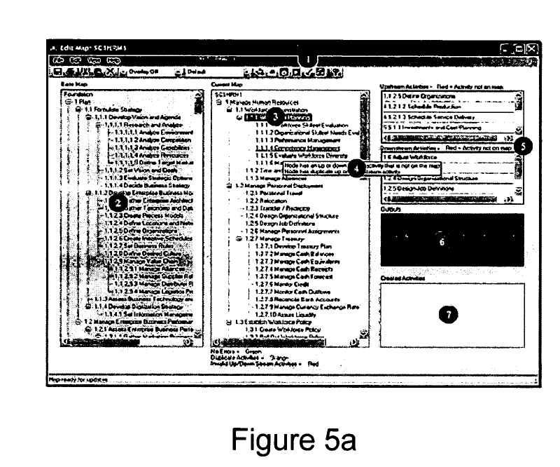

With reference now to the figures, and in particular with reference to FIG. 1, a pictorial representation of a distributed data processing system is depicted in which the present invention may be implemented. FIG. 1 as well as FIGS. 2 and 3 that follow, depict an environment on which a Client Enterprise Reference Map system may be implemented. The details of the Client Enterprise Reference Map are described starting with FIG. 4 further below.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. In addition, clients 108, 110 and 112 are also connected to network 102. These clients, 108, 110 and 112, may be, for example, personal computers or network computers. For purposes of this application, a network computer is any computer coupled to a network that receives a program or other application from another computer coupled to the network. In the depicted example, server 104 provides data, such as boot files, operating system images and applications, to clients 108-112. Clients 108, 110 and 112 are clients to server 104. Distributed data processing system 100 may include additional servers, clients, and other devices not shown. Distributed data processing system 100 also includes printers 114, 116 and 118. A client, such as client 110, may print directly to printer 114. Clients such as client 108 and client 112 do not have directly attached printers. These clients may print to printer 116, which is attached to server 104, or to printer 118, which is a network printer that does not require connection to a computer for printing documents. Client 110, alternatively, may print to printer 116 or printer 118, depending on the printer type and the document requirements.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network.

FIG. 1 is intended as an example and not as an architectural limitation for the processes of the present invention.

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries.

With reference now to FIG. 3, a block diagram of a data processing system in which the present invention may be implemented is illustrated. Data processing system 300 is an example of a client computer which may be used to display and manipulate a client enterprise reference map in accordance with the present invention. Client 300 may receive the Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

With reference now to FIGS. 4, 4a, 4b, 4c, 4d and 4e block diagrams representing the manner in which the present invention may be transformed into a computer application, called the Client Enterprise Reference Map, and presented to practitioners for application in the field, are depicted in accordance with one embodiment of the present invention.

FIG. 4 presents one manner in which the client enterprise reference map may be presented to the users. It is the master user interface, with the user initiating activity with the system in step 401. It is currently developed in Microsoft Windows XP using Microsoft's Net Enterprise developers software which are available from Microsoft Corporation of Redmond, Wash. “Windows XP” and “.Net” are trademarks of Microsoft Corporation. However, those skilled in the art will recognize that other developers software and environments may utilized instead of those described herein. Step 402 illustrates the first decision option presented too the user, that of using an existing map or creating a new map. Should the user choose to create a new map, step 403, they will activate the map creation module (step 404 and FIG. 4a).

Should the user choose to view an existing map in step 405 they are presented with a choice of viewing functional flows (step stream 406a-406c), overlays (step stream 407a-407c), flow types (step stream 408a-408c), activity information (step stream 409a-409c), activity flows (step stream 410a-410c) or displaying output links (step stream 411a-411c).

For all “a-c” step streams the user is provided the option of viewing the resulting map in Microsoft Visio available from Microsoft in Redmond Wash. “Microsoft Visio” is a trademark of Microsoft Corporation. Should the user choose to not view the Visio depiction of the map they will be returned to step 402.

Step streams 410 and 411 provide the additional functionality of reviewing detailed narrative information about an activity or activity flow (steps 410d and 410e) and linking out of the application to related corporate collateral (steps 411d and 411e).

Should the user choose in step 402 of FIG. 4 to create a new map the map creation sub-module is called (FIG. 4a, step 4a01). A new map can either be derived from an existing portfolio of maps or create an entirely new map. In either case the building blocks for the new map are the activities. Should the user choose in step 4a02 to create a completely new activity or group of activities, the “create and edit activities” sub-module is called, presenting the user with a new “pop-up” window (step 4a03 and FIG. 4b). Upon completing definition of the new activities, they are transferred back to map development screen via “drag and drop” in step 4a05.

Should choose the leverage an existing map elements from multiple existing maps they will highlight the desired activities with the mouse and transfer them into the map development screen via “drag and drop” in step 4a04.

Step 4a06 represents the new map development screen. This used to review the elements of the map as it is developed. Once the user is satisfied with the activities in the new map (step 4a07) they are able to add new overlays (step 4a08), flow types (step 4a10) and/or linked outputs (step 4a12) associated with the activities. Choosing to create an overlay will activate the “create/edit overlay” sub-module (step 4a09 and FIG. 4c). Choosing to create a flow type will activate the “create/edit flow type” sub-module (step 4a11 and FIG. 4d). Choosing to create an output link will activate the “create/edit output” sub-module (step 4a13 and FIG. 4e).

At any time in the development process the user can add/modify/delete activity relationships (step 4a14) by activating the “create/edit activity sub-module” (step 4a15). Once the user is satisfied with the results of the development, the work is saved, the development window is closed and the user is returned to step 402 in FIG. 4.

Should the user choose in step 4a02 in FIG. 4a to create a new activity the “create/edit new activity” sub-module is activated as depicted in FIG. 4b where the action is enter the name of the new activity in step 4b01. Steps 4b02-4b09 provide the user the opportunity to define the information associated with the new activity. The activity add and edit screen is derived from the master window.

Should the user choose in steps 4a09, 4a11 or 4a13 of FIG. 4a to create new overlays, flow types and/or output links the related sub-modules will be activated as described above. FIGS. 4c-4e are similar modules in which the user is provided with the option of editing or creating the targeted element (steps 4c01, 4d01 and 4e01). Choosing to create presents the user with a screen which has field names but no field data (steps 4c02 and 4c03 for overlays, 4d02 for flow types and 4e02 for output links). Choosing to edit or modify presents the user with same screen but populated with existing data (steps 4c04 for overlays, 4d03 for flow types and 4e03 for output links). In all three of these sub-modules saving and closing the associated windows returns the user to step 4a02 of FIG. 4a.

With reference now to FIGS. 5, 5a, 5b, 5c, 5d 5e, 5f, 5g, 5h and 5i provide related screenshots of a Beta version of a textual user interface which is exemplary of how the computer application may be presented to the users in accordance with one exemplary embodiment of the present invention.

FIG. 5: Upon activating the tool this will be the first screen displayed. This is the master window to which you will always return after performing an action.

It has seven areas of execution:

1. standard Windows menu with a mix of standard and tool specific functions available
2. standard windows toolbar with a mix of standard and tool specific functions available
3. tabs showing all maps which the user's security profile authorizes them to see [Note: Security is not activated for Beta 1.]
4. the central map area displaying the active map; all maps are structured as a hierarchy and each listed activity is “clickable”
5. upstream activities display area showing all activities upon which a selected activity in the central map area is dependant
6. downstream activities display area showing all activities which are dependant upon a selected activity in the central map area
7. status indicators for Object Flows, Outputs and Metrics

FIG. 5a: After the basis for a new or derivative map has been accomplished the next stage is to eliminate errors resulting from relationships with missing activities or from duplicated activities. The first step is to click on the “Edit” menu and select “Map” which will open the Edit Map window. Clicking in the “Check Map” button [1] causes the application to check through every activity in the new map and results in a color coded display of the integrity status of the map. Displayed in the left major pane [2] is the source map for the new map. This is primarily used as the source for adding missing activities.

By clicking on an activity [3] missing expected (by the system) related activities a summary of the activity status will be displayed [4] and a detailed listing of what is missing upstream and downstream provided in the related panes [5]. The upstream and downstream panes display all related activities differentiating between valid existing relationships (black text) and missing functions (red text).

For this particular map there were no Outputs associated with the highlighted activity. When there is no data type associated with a particular activity, its pane is grayed out [7]. Should an activity not have upstream or downstream related activities those panes will also be gray. New activities created for the map are shown in their respective window [7].

There are a number of ways to fix the activities revealed to have problems. For missing relationships there two approaches. The first is to simply find the missing activity in the source (parent) map and “drag & drop” it onto the activity in question; the error indicator will immediately disappear.

FIG. 5b: The second way to eliminate the errors is to click on the edit menu and select “Activity”; this will result in the screen shown above. To eliminate relationships not needed for the new map, simply click on the appropriate row header [1 & 2] and press “delete” on the keyboard. They are gone.

The “Edit Activity” can also be used to add/delete existing flow types (unique characteristics) [3], modify outputs [4] or create/edit/delete flow objects [5].

For duplicate activities, the application is performing a textual comparison. If two activities are highlighted as duplicates either the textual for one of them needs to be more accurate or one of the activities is unnecessary.

FIG. 5c: Flow objects are used to document the logic behind the chosen relationship between any two particular activities. Flow objects are created from the Edit an Activity window clicking on the “Create” button just over the flow object's pane [1]. Clicking here activates a “pop-up” window where the logic can be entered or altered in the “Memo” field [2].

FIG. 5d: Flow types are used to identify new characteristics associated with an activity and alternative downstream flow. For example, if an activity has typically had a monthly reporting cycle (default value from source map) and the situation being modeled by the new map requires quarterly reporting this can be documented via a new flow type.

To begin click on the “File” menu in the Edit Map window [1], selecting “New” and “Flow Type”. This will bring up the “New/Edit Activity Flow Type” window [2] where the information regarding the new characteristic can be added. Saving this information closes the “pop up” window and returns the user to the “Edit Map” window.

Highlighting and then right clicking on an activity in the central pane of the “Edit Map” window and selecting “edit” from the options brings up the “Edit an Activity” window. The selected activity will be displayed. Click on the drop down box for “Flow Type” [3] and select “Quarterly” from the options.

Frequently, changing the flow type for an activity will result in the activity's relationship with downstream activities. These activities can be changed using the “Downstream Activities” dropdown box [4].

FIG. 5e: Overlays are used to associate metrics or “flag” type attributes with an activity. An overlay could be created matching EDS portfolio offerings with enterprise activities, identifying cost, profitability by industry or geography etc. Eventually, it is envisioned that much of the dynamic data captured and displayed in overlays will be fed into the CERM database electronically and real time.

Overlays are created by clicking on the “File” menu of the “Edit Map” window and selecting “New” and “Overlay”, resulting in the depicted pop-up window. Theoretically, there is no limit to number of specific line items that can be defined for the overlay. Once an overlay has been defined it can then be associated with any activity in the active map and particular line items selected based on relevance.

FIG. 5f: Overlays are displayed in tabular format with enterprise activities listed in rows and the metric/attribute shown as columns.

FIG. 5g: Links can be made to entities external to the CERM tool. In CERM these links are viewed as “Outputs” of an activity. Creation and editing of Output links is accomplished by clicking on the “View” menu of the master CERM window and selecting “Outputs”.

FIG. 5h: Output links can be to any electronic locations (URLs, documents, enterprise systems, etc.) which the user is authorized to access.

FIG. 5i: The output mechanism for the CERM user interface is Visio. This is accessed by clicking on the “View” menu in the master window and selecting “Visio Map”. Output can be viewed either on-screen or sent to a plotter for creating poster size wall.

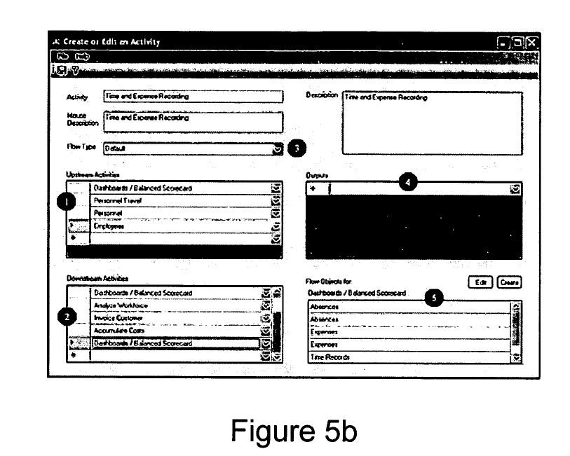

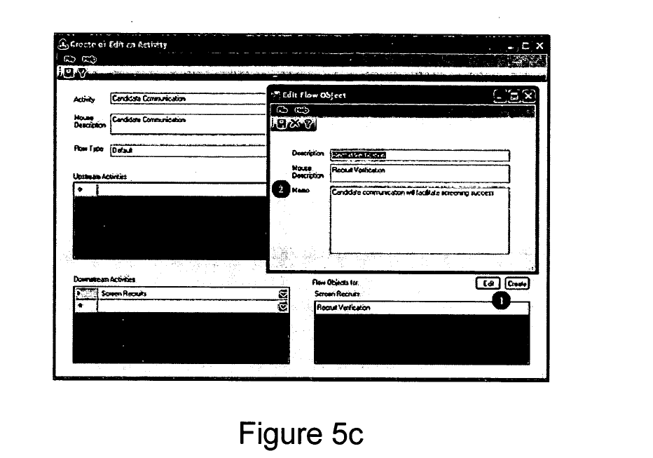

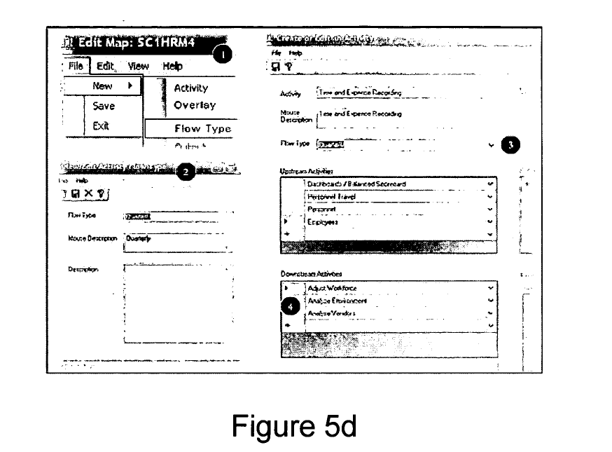

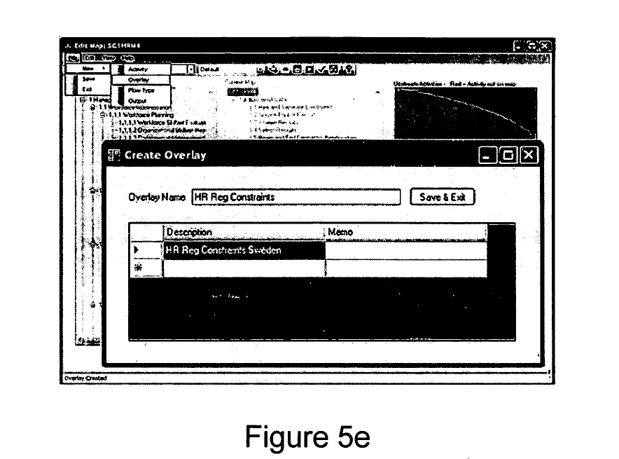

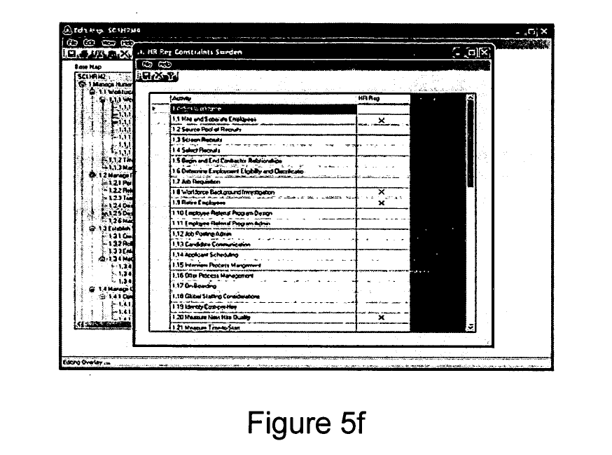

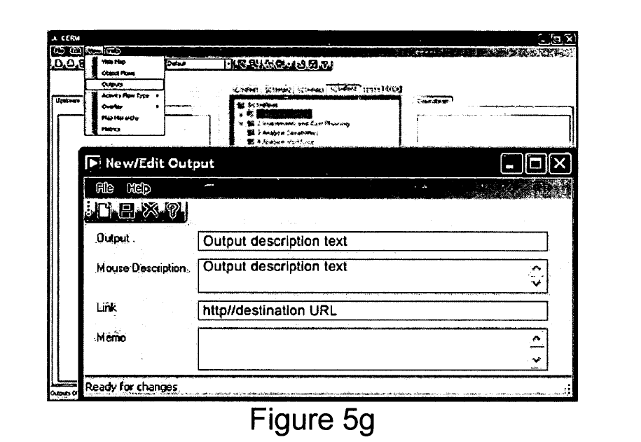

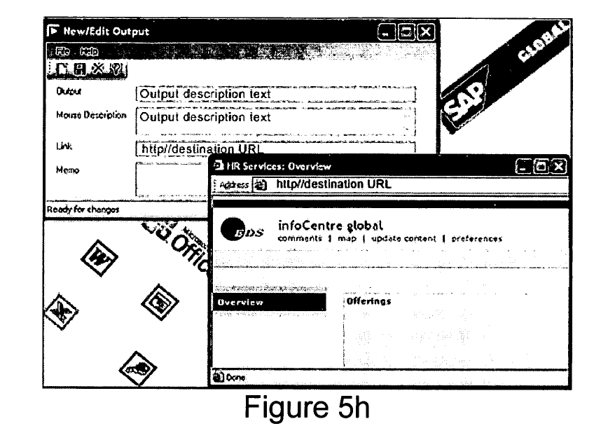

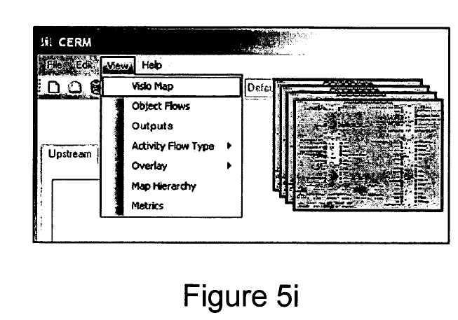

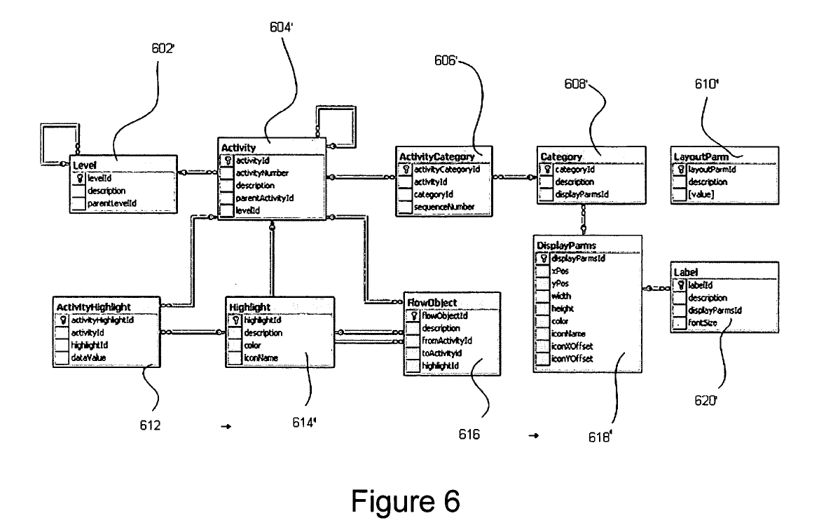

With reference now to FIG. 6, an exemplary data model for a data element 600 in a Client Enterprise Reference Map Database is depicted in accordance with one embodiment of the present invention.

Data element 600 includes data descriptors 602-620 which describe the type of element, how and where to depict the element 600 in a client enterprise reference map. Descriptor 602

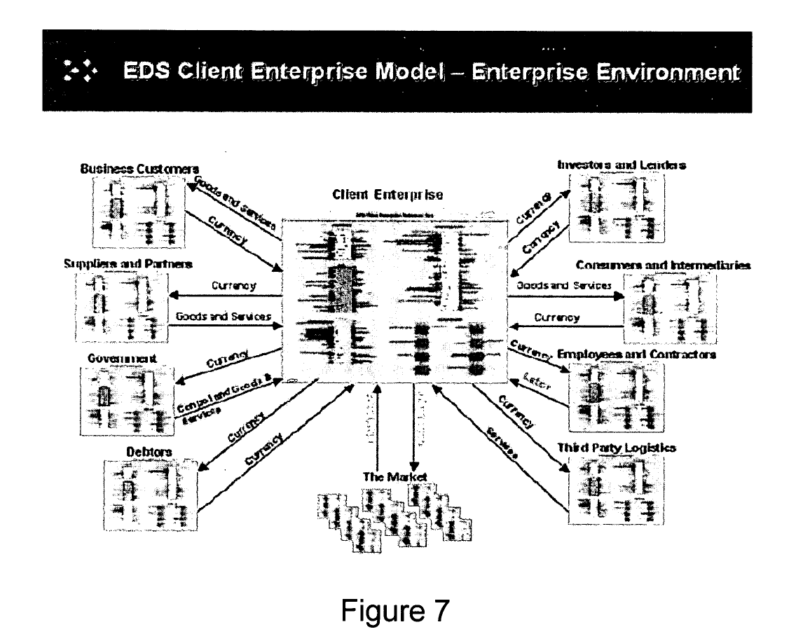

With reference now to FIG. 7, an exemplary view of a client enterprise reference map is depicted in accordance with one embodiment of the present invention.

Map 700 is one of the basic views of the Client Enterprise Reference Map. Map 700 shows the hierarchy of activities performed, the input and output information/object flows of each activity, the external enterprises interacted with and their inputs and outputs, and various statistics such as costs, value, object counts, path counts, or offering overlap concerning the activities and flows shown.

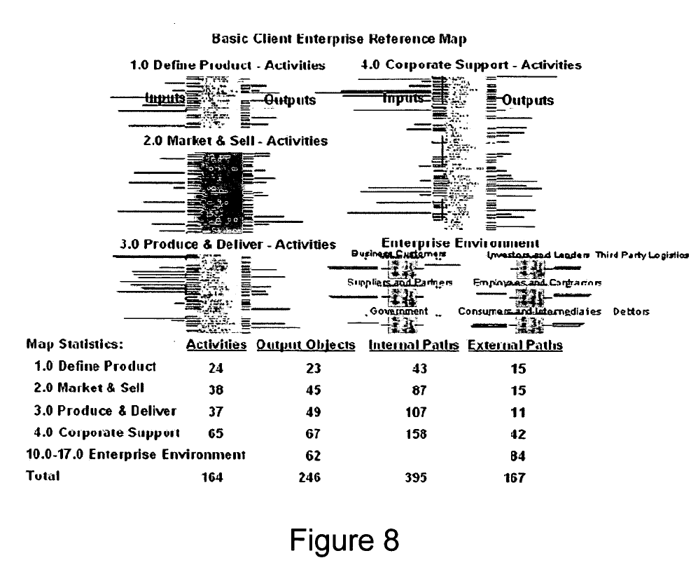

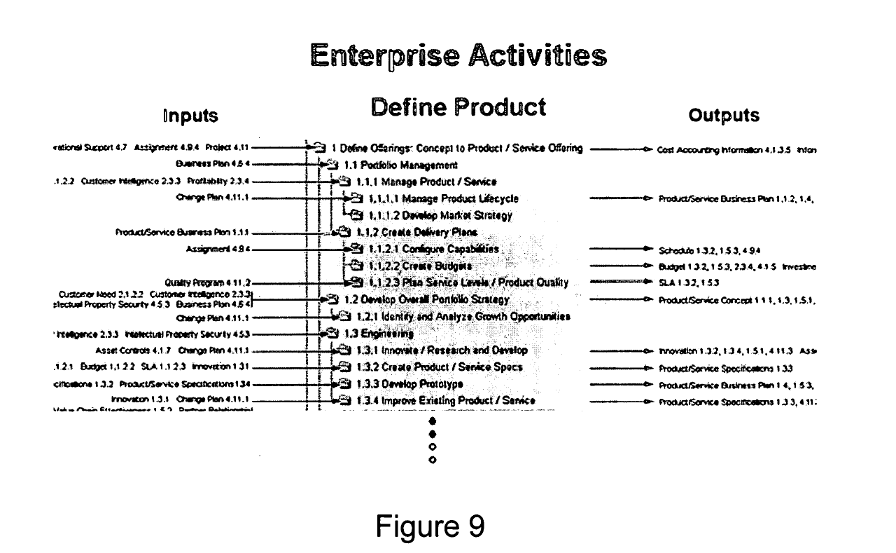

FIG. 8 depicts another view or map 800 that may be provided by the client enterprise reference map system. FIG. 9 depicts a portion 802 of map. 800 zoomed in on to show greater detail enabling the user(s) to review a particular set of activity flows or relationships within the enterprise context.

Although described primarily with reference to implementation using Microsoft XP, Microsoft's Net Enterprise developers software, and Microsoft Visio, the present invention is not limited to implementation using these software tools. Those skilled in the art will recognize that other software tools may be utilized as well depending on, for example, the requirements and preferences of the programmer and/or users.

To aid the Patent Office, and any readers of any patent issued on this application in interpreting the claims appended hereto, it is noted that applicant does not intend any of the appended claims to invoke paragraph 6 of 35 U.S.C. § 112 as it exists on the date of filing unless the words “means for” are used in the particular claim. Furthermore, none of the description in the present application should be read as implying that any particular element, step, or function is an essential element which must be included in the claim scope: THE SCOPE OF THE PATENTED SUBJECT MATTER IS DEFINED ONLY BY THE ALLOWED CLAIMS. Thus, the extent of legal protection will be determined by the limitations recited in the allowed claims and their equivalents. Unless explicitly recited, other aspects of the present invention as described in this specification do not limit the scope of the claims.

As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for organizing and managing business activities and functions, the method comprising:
maintaining a data storage of business data, wherein the business data comprises metric and activity based data and wherein the business data includes a plurality of business activities wherein each business activity contains at least one indicia indicating a category to which the business activity belongs and wherein the data storage contains overlay data corresponding to at least one of the business activities;
generating and presenting to a user an interactive graphical representation of business activities grouped by category indicating the relationship of business activities to other business activities wherein at least some of the business activities are represented by selectable graphical indicia based on information contained in the data storage; and
responsive to selection of a graphical indicia by a user, presenting the user with information concerning the business activity represented by the graphical indicia.

2. The method as recited in claim 1, wherein presenting the user with information concerning the business activity represented by the graphical indicia comprises at least one of providing links to corporate collateral, metrics obtained from other systems, overlay data, activity information, activity flows, and functional flows.

3. The method as recited in claim 1, wherein presenting to a user the graphical representation of business activities comprises presenting the user with a view of at least one of functional flows, overlays, flow types, activity information, activity flows, and output links.

4. The method as recited in claim 1, wherein the data storage comprises at least one of metric data and activity data.

5. The method as recited in claim 1, wherein the selection of a graphical indicia by a user presents the user with one of at least two alternative flow types wherein the particular one of the at least two alternative flow types presented is event driven.

6. The method as recited in claim 1, wherein maintaining the data storage comprises at least one of creating new enterprise reference maps and editing an existing enterprise reference map.

7. The method as recited in claim 1, wherein maintaining the data storage comprises at least one of creating and editing at least one of new overlays, flow types and output links the related sub-modules.

8. The method as recited in claim 1, wherein business activities includes at least one of client business activities and an outsourcing provider's capabilities as it relates to business functions.

9. The method as recited in claim 1, wherein the business activities are grouped by at least one of industry and client identity.

10. The method as recited in claim 1, wherein the database contains overlay data corresponding to at least one business activity that provide at least one of cost-based and value-based overlays for the corresponding business activity.

11. The method as recited in claim 1, wherein the interactive graphical representation is one of cross-industry specific, industry-specific, and client-specific.

12. The method as recited in claim 1, wherein the graphical representation provides a work flow model for a relevant one of a business activity, a line of business, a client, and an industry.

13. The method as recited in claim 1, wherein the business activities comprise work object flows.

14. A computer program product in a computer readable media for use in a data processing system for organizing and managing business activities and functions, the computer program product comprising:
first instructions for maintaining a data storage business data, wherein the business data comprises metric and activity based data and wherein the business data includes a plurality of business activities wherein each business activity contains at least one indicia indicating a category to which the business activity belongs and wherein the data storage contains overlay data corresponding to at least one of the business activities;
second instructions for generating and presenting to a user an interactive graphical representation of business activities grouped by category indicating the relationship of business activities to other business activities wherein at least some of the business activities are represented by selectable graphical indicia based on information contained in the data storage; and
third instructions for presenting a user with information concerning the business activity represented by the graphical indicia responsive to selection of a graphical indicia by the user.

15. The computer program product as recited in claim 14, wherein the third instructions comprise at least one of providing links to corporate collateral, metrics obtained from other systems, overlay data, activity information, activity flows, and functional flows.

16. The computer program product as recited in claim 14, wherein the third instructions comprise presenting the user with a view of at least one of functional flows, overlays, flow types, activity information, activity flows, and output links.

17. A system for organizing and managing business activities and functions, the system comprising:
first means for maintaining a data storage business data, wherein the business data comprises metric and activity based data and wherein the business data includes a plurality of business activities wherein each business activity contains at least one indicia indicating a category to which the business activity belongs and wherein the data storage contains overlay data corresponding to at least one of the business activities;
second means for generating and presenting to a user an interactive graphical representation of business activities grouped by category indicating the relationship of business activities to other business activities wherein at least some of the business activities are represented by selectable graphical indicia based on information contained in the data storage; and
third means for presenting a user with information concerning the business activity represented by the graphical indicia responsive to selection of a graphical indicia by the user.

18. The system as recited in claim 17, wherein the third means comprise at least one of providing links to corporate collateral, metrics obtained from other systems, overlay data, activity information, activity flows, and functional flows.

19. The system as recited in claim 17, wherein the third means comprise presenting the user with a view of at least one of functional flows, overlays, flow types, activity information, activity flows, and output links.
